(19) United States
(12) Patent Application Publication
(10) Pub. No.: US 2006/0125781 A1
(43) Pub. Date: Jun. 15, 2006

(54) Sliding structure location on a pointing device corrected for non-linearity of measured differential

(76) Inventors: Todd S. Sachs, Palo Alto, CA (US); Jonah A. Harley, Mountain View, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/012,966

(22) Filed: Dec. 15, 2004

(51) Int. Cl. G09G 5/00

(52) U.S. Cl. 345/156

(57) ABSTRACT

A pointing device has a pointing device surface and a sliding structure that moves with respect to the pointing device surface. A detector outputs a value that varies as the sliding structure moves with respect to the pointing device surface. A controller estimates the sliding structure location on the pointing device surface by calculating an approximate distance. The approximate distance is calculated by multiplying a measured differential of the value times a conversion constant. The controller adjusts the approximate distance to take into account non-linearity of the measured differential.

### RELATED CASE

The subject matter of the present case is related to the subject matter set out in U.S. patent application Ser. No. 10/723,957, by Jonah Harley, et al., filed Nov. 24, 2003 for Compact Pointing Device.

### BACKGROUND

A pointing device is often used with computing devices for making selections and for controlling the position of a cursor on a computer display. For example, a mouse is a hand held object that is moved over a flat surface to control the motion of a cursor on the computer display. The direction and distance over which the mouse is moved determines the direction and distance the cursor moves on the display. One or more buttons on top of the mouse allow for a user to make various selections. When a workspace is not large enough to provide a path over which the mouse can move and accommodate a desired cursor movement on the display, the user can pick up the mouse and re-center the mouse in the workspace.

A trackball tracks rotational movement of a ball mounted on a keyboard or mounted separate from the keyboard. Movement of the ball controls motion of the cursor. Other pointing devices available for use with computing systems include, for example, the Synaptics capacitive TouchPad™ and the IBM TrackPoint™.

### SUMMARY OF THE DISCLOSURE

In accordance with an embodiment of the present invention, a pointing device has a pointing device surface and a sliding structure that moves with respect to the pointing device surface. A detector outputs a value that varies as the sliding structure moves with respect to the pointing device surface. A controller estimates the sliding structure location on the pointing device surface by calculating an approximate distance. The approximate distance is calculated by multiplying a measured differential of the value times a conversion constant. The controller adjusts the approximate distance to take into account non-linearity of the measured differential.

### BRIEF DESCRIPTION OF THE DRAWINGS

FIG. 1 shows a top view of a pointing device in accordance with an embodiment of the present invention.

FIG. 2 shows a side view of the pointing device shown in FIG. 1 in accordance with an embodiment of the present invention.

FIG. 3 illustrates motion and operation of a pointing device in accordance with an embodiment of the present invention.

FIG. 4 is a block diagram showing a simplified model of electrical operation of a pointing device in accordance with an embodiment of the present invention.

FIG. 5 is a simplified illustration illustrating non-linearity of operation of the pointing device shown in FIG. 4.

### DESCRIPTION OF THE EMBODIMENT

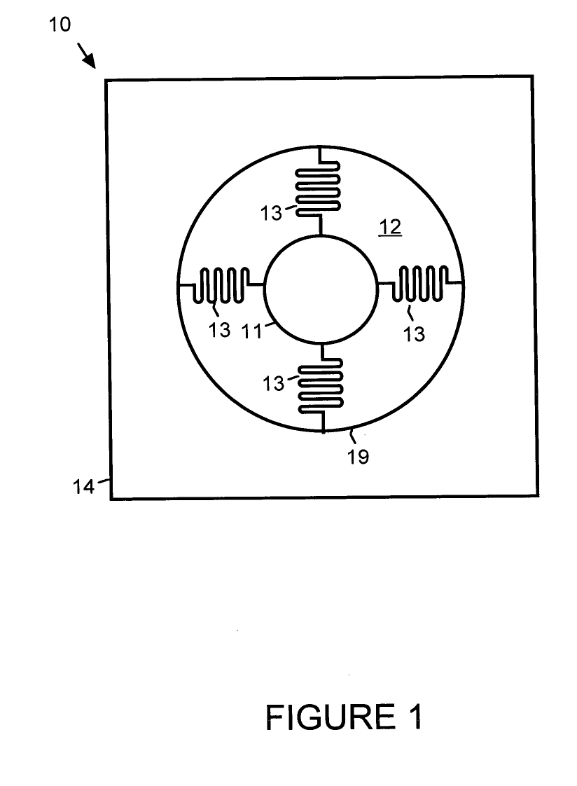

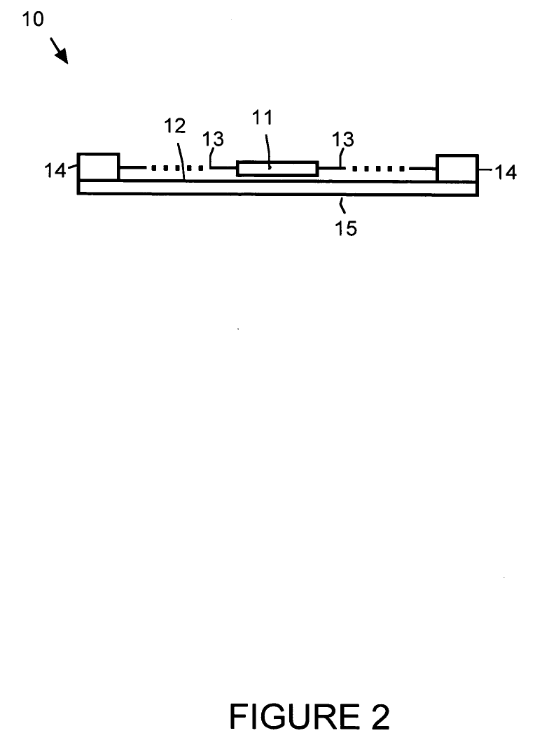

FIG. 1 shows a top view of a pointing device 10. FIG. 2 shows a side view of pointing device 10. Pointing device 10 includes a sliding structure 11 that moves over a surface 12 of a substrate 15 within a sliding structure field of motion defined by a circle 19. Sliding structure 11 moves in response to a lateral force applied to sliding structure 11. The force is typically applied to sliding structure 11 by a user's finger, finger tip, thumb, thumb tip or multiple fingers. Sliding structure 11 includes a pressure sensing mechanism that measures the vertical pressure applied to sliding structure 11. In addition, pointing device 10 includes a sensing mechanism for determining the position of sliding structure 11 on surface 12.

For example, when the user applies a vertical force to sliding structure 11 that is greater than a predetermined threshold, any change in the position of sliding structure 11 on surface 12 is reported to a host device. Pointing device 10 can be separate from the host device or integrated into the host device. For example, the change in position is used to move a cursor on the display by a magnitude and a direction that depends on the magnitude and direction of the motion of sliding structure 11 while the vertical force is applied to sliding structure 11.

For example, in one embodiment of the present invention, the pressure sensor in sliding structure 11 senses two predetermined pressure levels. The first level is used to actuate the tracking of the cursor on the display as described above. The second level is used to implement the “click” function associated with a conventional mouse. Hence, the user can click at the current position of the cursor by increasing the pressure applied to sliding structure 11. A mechanical click can also be engineered to provide tactile feedback for the “click” threshold.

Alternatively, other mechanisms can be utilized for signaling the cursor coupling. For example, the presence of the user's finger on the sliding structure can be sensed using capacitance differentials. For example, the presence of the user's finger measurably alters the capacitance of one or more electrodes on the sliding structure. Alternatively, the user sensor may also be implemented without a separate force or capacitance sensor, but rather by software analysis of the sliding structure x and y positions. When the sliding structure is snapping back to the center under the force of re-centering springs, the direction and acceleration of the sliding structure motion can be used to determine if the sliding structure is being manipulated by the user or is just under the influence of a centering device.

When the user releases sliding structure 11 by removing the user's finger, sliding structure 11 is returned to its centered position by springs 13. Springs 13 connect sliding structure 11 to sides 14 of the sliding structure field of motion. Since the user's finger is not applying a vertical force to sliding structure 11 during its return, the change in position associated with that return motion is not reported to the host device. That is, cursor 101 remains at location 102. This re-centering mode provides a convenient “re-centering” capability, typically achieved on a mouse by lifting and replacing the mouse at the center of the field of motion. Use of a re-centering mode is particularly necessary in laptop computers, hand-held devices and other miniature applications in which the field of motion is constrained.

In various embodiments of the invention, modes in addition to the re-centering modes can be implemented. For example, in a “1-to-1” mode, there is a 1-to-1 mapping between movement of sliding structure 11 and movement of the cursor on a display. That is, when sliding structure 11 is returned to its centered position by springs 13, the cursor on the display also returns to its centered position on the display. The 1-to-1 mode is ideally suited for use with small displays, where the whole display can be easily traversed through movement of sliding structure 11, without the need for re-centering.

In a joystick mode, the position of sliding structure 11 is mapped to the velocity of the cursor. In joystick mode, when sliding structure 11 is held at a constant non-centered position, the cursor will travel with a certain velocity based on the radial distance of sliding structure 11 to a center position. The direction of cursor movement is based on the direction of a vector from the center position to current position of sliding structure 11.

For example springs 13 are implemented as meander springs. Alternatively, springs 13 can be implemented as common helical coiled springs. Alternatively, springs 13 can be implemented using a spiral spring design. While FIG. 1 shows utilization of four springs for restoring sliding structure 11 to its resting position, other numbers of springs can be utilized. In principle, one spring could be used; however, the spring would need to provide the return force in two directions, and hence, would no longer be isotropic, and would be much stiffer than the springs described above. In addition, more springs can be used to provide additional electrical connections to the sliding structure.

Springs 13 ideally return sliding structure 11 to a resting position that is in the center of the field of motion. However, sliding structure 11 need not be returned exactly to the same starting position each time it is released. Similarly, sliding structure 11 need not return to a resting position that is exactly in the center of the sliding structure field of motion.

Springs 13 can be replaced, for example, by other mechanisms for restoring sliding structure 11 to its resting position. For example, the sliding structure may include a magnet that is attracted to a corresponding magnet within the substrate under the sliding structure.

Alternatively, embodiments of the present invention can be constructed in which the restoring mechanism is the user's finger. In such an embodiment, the user would reduce the pressure on the sliding structure to a level below the level at which the coupling of the sliding structure to the cursor occurs. The user can then move the sliding structure to a new location manually without engaging the cursor on the display. The user can then continue the cursor movement by once again pressing on the sliding structure with sufficient pressure to activate the coupling of the sliding structure and the cursor.

While FIG. 1 shows a sliding structure field of motion that is circular, the sliding structure field of motion can have other shapes. For example, the sliding structure field of motion can be elliptical or rectangular. In these cases, the optimal spring shapes will be different than those described above.

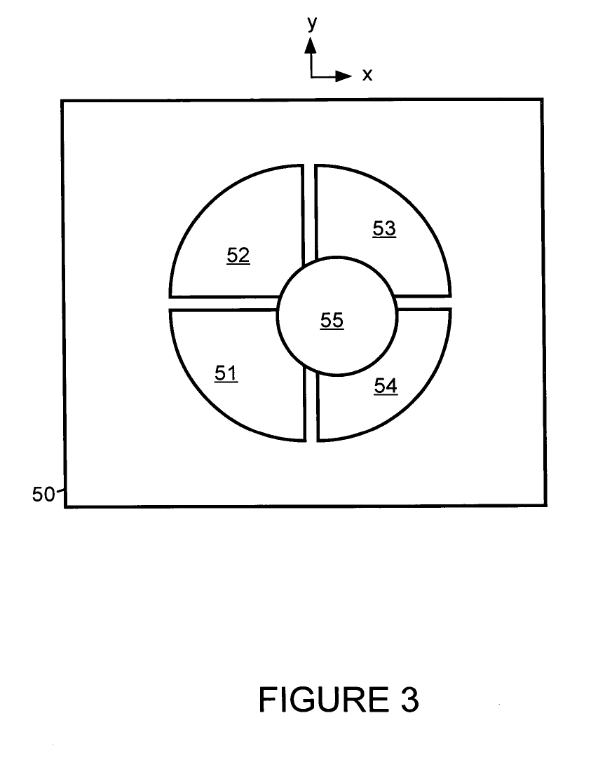

FIG. 3 illustrates motion and operation of pointing device 10 shown in FIGS. 1 and 2. For example, sliding structure 11 (shown in FIG. 1) includes a sliding structure electrode 55, shown in FIG. 3. Surface 12 (also shown in FIG. 1) includes an electrode 51, an electrode 52, an electrode 53 and an electrode 54, shown in FIG. 3. Electrodes 51 through 54 have terminals that are connected to an external circuit. To simplify the drawing, these terminals have been omitted. Sliding structure electrode 55 is located on a bottom of sliding structure 11 (shown in FIG. 1). Electrodes 51 through 55 are electrically isolated from one another. For example, sliding structure electrode 55 can be covered with a layer of dielectric that provides the required insulation while still allowing sliding structure electrode 55 to slide over the electrodes 51 through. Alternatively, electrodes 51 through 54 can be patterned on the back of substrate 15 (shown in FIG. 2). This reduces the capacitance between the electrodes 51 through 54 and sliding structure electrode 55, but can be practical for substrate thicknesses a few millimeters or less.

The overlap between sliding structure electrode 55 and each of electrodes 51 through 54 depends on the position of the sliding structure relative to electrodes 51 through 54. As illustrated in FIG. 3, sliding structure electrode 55 is off center so that sliding structure electrode 55 covers more of electrode 54, than sliding structure electrode 55 covers of electrode 51, electrode 52 or electrode 53.

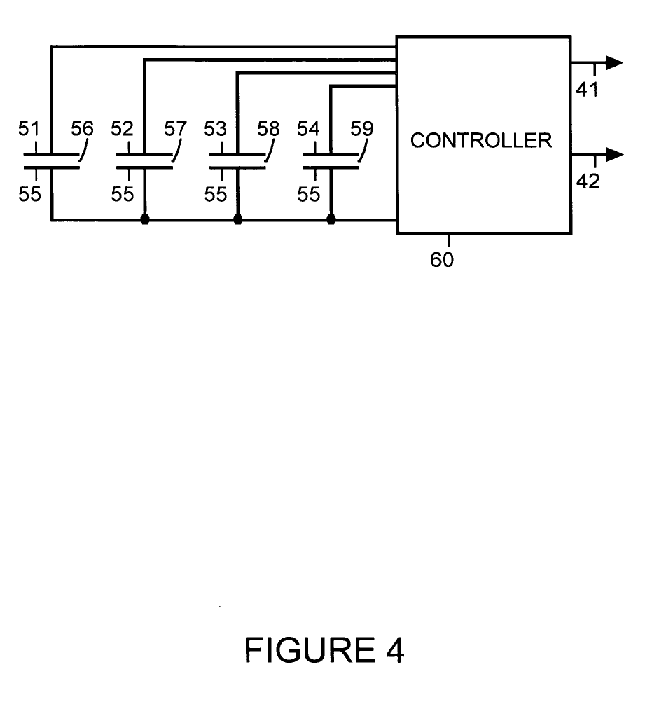

FIG. 4 is a block diagram showing a simplified model of electrical operation of pointing device 10. Each of electrodes 51 through 54 forms a capacitor with a portion of sliding structure electrode 55. For example, electrode 51 and a portion of sliding structure electrode 55 that overlaps electrode 51 form a parallel plate capacitor 56 with a capacitance that is proportional to the area of overlap. Electrode 52 and a portion of sliding structure electrode 55 that overlaps electrode 52 form a parallel plate capacitor 57 with a capacitance that is proportional to the area of overlap. Electrode 53 and a portion of sliding structure electrode 55 that overlaps electrode 53 form a parallel plate capacitor 58 with a capacitance that is proportional to the area of overlap. Electrode 54 and a portion of sliding structure electrode 55 that overlaps electrode 54 form a parallel plate capacitor 59 with a capacitance that is proportional to the area of overlap. Parallel capacitors 56 through 59 function as a detector whose output varies as sliding structure 55 moves with respect to the pointing device surface.

By measuring the capacitance between sliding structure electrode 55 and each of electrodes 51 through 54, the position of sliding structure electrode 55 relative to electrodes 51 through 54 can be determined. This determination can be made by a controller 60, which, for example, can be dedicated to detecting positions of sliding structure electrode, or can be implemented by functionality within a host device. For example, controller 60 generates a delta X value 41 and a delta y value 42. For example, delta X value 41 represents current distance of sliding structure 55 in an x direction from a center position. Likewise, delta Y value 4w represents current distance of sliding structure 55 in a y direction from the center position.

The use of four electrodes is exemplary. For example, in embodiments in which the sliding structure field of motion is substantially greater than the diameter of the sliding structure, more than four electrodes can be placed on the substrate. Alternatively, three or even two electrodes are a sufficient number to calculate two dimensions of sliding structure location. Capacitance measurements between each electrode and the sliding structure can be used to determine the sliding structure position as described above.

For example, the electrical connection to sliding structure electrode 55 (shown in FIG. 3) on the bottom of sliding structure 11 (shown in FIG. 1) can be eliminated in embodiments that measure the capacitive coupling between each pair of electrodes on surface 12. That is, the capacitance between electrodes 51 and 52 can be measured separately from the capacitance between electrodes 51 and 53, and so on. Four measurements between adjacent electrodes provide information to solve for each of four capacitances, and thereby determine the sliding structure position.

For example, sliding structure electrode 55 is preferably circular in shape to reduce errors arising from the shape of the electrode. Restoring springs 13 allow sliding structure 11 to rotate somewhat. If the user's finger is not centered on sliding structure 11 during the motion of sliding structure 11, the resultant torque can cause the sliding structure 11 to rotate slightly. If sliding structure electrode 55 is circularly symmetric, such rotations will not alter the result of the position measurement. If, on the other hand, sliding structure electrode 55 is not circularly symmetric, the overlap between the sliding structure and the various electrodes will be different for different rotations, even though the center of sliding structure 11 is at the same location in each case. Nevertheless, other sliding structure electrode shapes can be used where this advantage is not desired.

In the above-described embodiments of the present invention, the position detection is done capacitatively because such measurements are less effected by dirt accumulating on the surface of the electrodes or wear in the surface of the sliding structure or the electrodes, and consume very little power. However, other position detection mechanisms can also be utilized. For example, the pointing device surface can be coded with a resistive layer with electrodes located on four corners of the surface. Conductivity between an electrode on the bottom of the sliding structure and each of the electrodes can be measured to determine the location of the sliding structure on the surface.

The position of the sliding structure in the sliding structure field of motion can also be ascertained using optical sensors such as those used in a conventional optical mouse. The position of the sliding structure in the sliding structure field of motion can also be ascertained using variations in magnetic fields. The preceding examples of suitable positioning mechanisms are provided as examples. However, it will be apparent from the preceding discussion that there are a large number of position-measuring mechanisms that can be utilized without departing from the teachings of the present invention.

The distance through which the cursor is to move can be greater than the maximum distance that can be moved by moving the sliding structure from its resting position in the center of the sliding structure field of motion to the boundary of the sliding structure field of motion. In this case, the user can make the required cursor movement in a manner analogous to that used with conventional mice, namely, re-center the sliding structure by releasing the sliding structure and then re-engaging the sliding structure by placing a finger on the sliding structure. Since the cursor was disengaged when the finger was removed prior to re-centering of the sliding structure, the user can resume moving the cursor on the display from the position on the display at which the user's finger was removed from the sliding structure.

In the embodiment shown in FIG. 3 and FIG. 4, controller 60 can check pairs of electrodes when determining relative location of sliding structure electrode 55 with respect to electrodes 51 through 54.

For example, when determining relative location of sliding structure electrode 55 in an x direction, controller 60 can check total capacitance of electrodes 51 and 52 with respect to sliding structure electrode 55. Alternatively, or in addition, controller 60 can check total capacitance of electrodes 53 and 54 with respect to sliding structure electrode 55.

Likewise, when determining relative location of sliding structure electrode 55 in a y direction, controller 60 can check total capacitance of electrodes 52 and 53 with respect to sliding structure electrode 55. Alternatively, or in addition, controller 60 can check total capacitance of electrodes 51 and 54 with respect to sliding structure electrode 55.

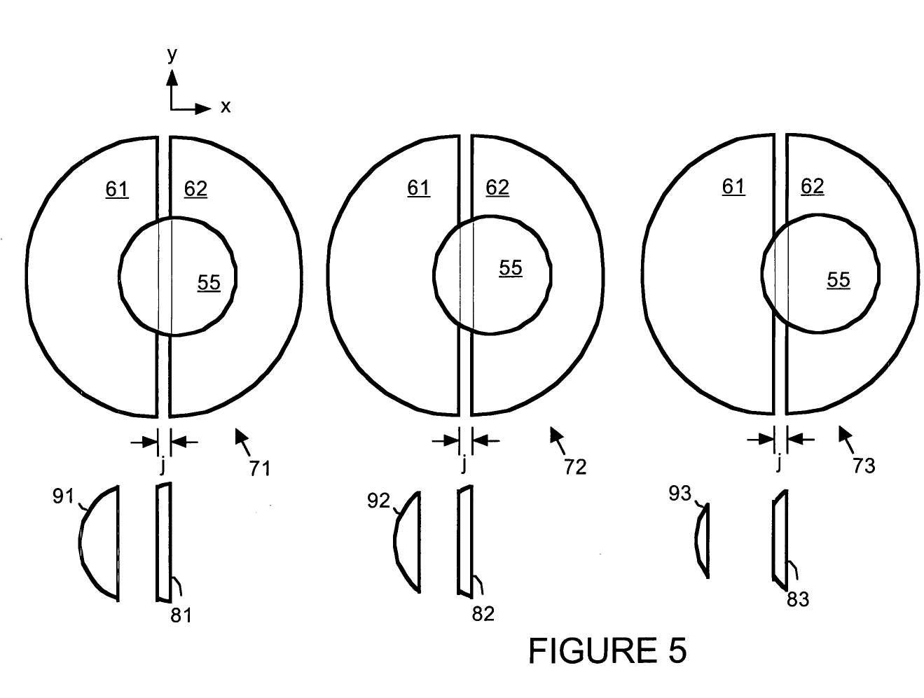

FIG. 5 illustrates using pairs of electrodes when measuring movement of sliding structure electrode 55 in the x direction. Electrode 61 (shown in FIG. 5) represents the combination of electrode 51 and electrode 52 (shown in FIG. 3). Electrode 62 (shown in FIG. 5) represents the combination of electrode 53 and electrode 54 (shown in FIG. 3).

As represented by a position 71, when sliding structure electrode 55 moves a distance “j” in the “x” direction from a center position, the area of overlap between sliding structure electrode 55 and electrode 61 is lessened by a reduction area 81. The remaining area of overlap between sliding structure electrode 55 and electrode 61 is represented by a remaining area 91.

As represented by a position 72, when sliding structure electrode 55 again moves the distance “j” in the “x” direction, the area of overlap between sliding structure electrode 55 and electrode 61 is lessened by a reduction area 82. The remaining area of overlap between sliding structure electrode 55 and electrode 61 is represented by a remaining area 92.

As represented by a position 73, when sliding structure electrode 55 again moves the distance “j” in the “x” direction, the area of overlap between sliding structure electrode 55 and electrode 61 is lessened by a reduction area 83. The remaining area of overlap between sliding structure electrode 55 and electrode 61 is represented by a remaining area 93.

While in the three positions 71 through 73 shown in FIG. 5, the movement in the x direction is a constant amount “j” between positions, change in the respective reduction areas 81 through 83 is not equal. This can result in a significant non-linearity in the detection of capacitance utilizing the respective remaining areas 91 through 93. The non-linearity results because sliding structure electrode 55 is in the shape of a circle rather than a square. The non-linear effect becomes more noticeable the further sliding structure electrode 55 travels from the center position.

In an embodiment of the present invention, when controller 59 calculates delta X value 41 and delta Y value 42 from measured capacitance, controller 59 makes adjustment to take into account the non-linearity.

The adjustment may be done in a number of ways. For example, delta X value 41 can be calculated using Equation 1 below:
A=(C1−C0)×Converter Equation 1
If |A|<=Start, then
   Delta =A
If |A|>Start, then
   If A>0, then
      Delta =A+(A−Start)*Slope
   If A<0, then
      Delta X=A+(A+Start)*Slope

In Equation 1, “CX0” represents total capacitance of electrodes 51 and 52 with respect to sliding structure electrode 55 at the center position. “CX1” represents total capacitance of electrodes 51 and 52 with respect to sliding structure electrode 55 at a current position. “Converter” is a conversion constant used to convert a capacitance differential to an approximate distance “A”. “Start” is a threshold value that, for example, may be determined empirically, depending upon desired accuracy. “Slope” is a correctional value that also may be determined empirically.

Likewise, delta Y value 42 can be calculated using Equation 2 below:
B=(CY1−CY0)×Converter Equation 2
If |B|<=Start, then
   Delta Y=B
If |B|>Start, then
   If B>0, then
      Delta Y=B+(B−Start)*Slope
   If B<0, then
      Delta Y=B+(B+Start)*Slope

In Equation 2, “CY0” represents total capacitance of electrodes 52 and 53 with respect to sliding structure electrode 55 at the center position. “CY1” represents total capacitance of electrodes 52 and 53 with respect to sliding structure electrode 55 at a current position. “Converter” is also used as a conversion constant to convert a capacitance differential to an approximate distance “B”. “Start” is also used as a threshold value and “Slope” is used as a correctional value.

Equation 1 and Equation 2 correct for first order non-linearity. Additional terms may be added if greater accuracy is desired. Alternatively, corrected distance values can be calculated using one or more tables. Alternatively, another method can be used to correct for non-linearity of measured capacitance differentials.

While Equation 1 and Equation 2 assume location of sliding structure 11 is calculated using capacitance differential, similar corrections for non-linearity can be used where necessary when location of sliding structure 11 is calculated using, for example, resistance differential, inductance differential, magnetic field differential, and so on.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A method for calculating a sliding structure location on a pointing device surface, the method comprising:
calculating an approximate distance by multiplying a measured differential times a conversion constant; and,
adjusting the approximate distance to take into account non-linearity of the measured differential.

2. A method as in claim 1 wherein the measured differential is a measured capacitance differential.

3. A method as in claim 1 wherein the measured differential is one of the following:
a magnetic field differential;
a resistance differential; or,
an inductance differential.

4. A method as in claim 1 wherein adjusting the approximate distance is performed using a first order correction value.

5. A method as in claim 1 wherein adjusting the approximate distance is performed using one or more tables.

6. A method as in claim 1 wherein adjusting the approximate distance in an “x” direction is performed using the following equation:
If |A|<=Start, then
Delta X=A
If |A|>Start, then
If A>0, then
Delta X=A+(A−Start)*Slope
If A<0, then
Delta X=A+(A+Start)*Slope
wherein A is the approximate distance in the x direction, Delta X is an adjusted value in the x direction, “Start” is a threshold value and “Slope” is a first order correctional value constant.

7. A method as in claim 6 wherein adjusting the approximate distance in a “y” direction is performed using the following equation:
If |B|<=Start, then
Delta X=B
If |B|>Start, then
If B>0, then
Delta X=B+(B−Start)*Slope
If B<0, then
Delta X=B+(B+Start)*Slope
wherein B is the approximate distance and Delta Y is an adjusted value in the Y direction.

8. A pointing device, comprising:
a pointing device surface;
a sliding structure that moves with respect to the pointing device surface;
a detector that outputs a value that varies as the sliding structure that moves with respect to the pointing device surface; and
a controller that estimates the sliding structure location on the pointing device surface by calculating an approximate distance, the approximate distance being calculated by multiplying a measured differential of the value times a conversion constant, the controller adjusting the approximate distance to take into account non-linearity of the measured differential.

9. A pointing device as in claim 8 wherein the measured differential is a measured capacitance differential.

10. A pointing device as in claim 8 wherein the measured differential is one of the following:
a magnetic field differential;
a resistance differential; or, an inductance differential.

11. A pointing device as in claim 8 wherein adjusting the approximate distance is performed using a first order correction value.

12. A pointing device as in claim 8 wherein adjusting the approximate distance is performed using one or more tables.

13. A pointing device as in claim 8 wherein adjusting the approximate distance in an “x” direction is performed using the following equation:
If |A|<=Start, then
Delta X=A
If |A|>Start, then
If A>0, then
Delta X=A+(A−Start)*Slope
If A<0, then
Delta X=A+(A+Start)*Slope
wherein A is the approximate distance in the x direction, Delta X is an adjusted value in the x direction, “Start” is a threshold value and “Slope” is a first order correctional value constant.

14. A pointing device as in claim 13 wherein adjusting the approximate distance in a “y” direction is performed using the following equation:
If |B|<=Start, then
Delta X=B
If |B|>Start, then
If B>0, then
Delta X=B+(B−Start)*Slope
If B<0, then
Delta X=B+(B+Start)*Slope
wherein B is the approximate distance and Delta Y is an adjusted value in the Y direction.

15. A computing device, comprising:
a pointing device, the pointing device including:
a pointing device surface;
a sliding structure that moves with respect to the pointing device surface;
means for generating a value that varies as the sliding structure moves with respect to the pointing device surface; and
means for calculating the sliding structure location on the pointing device surface by calculating an approximate distance, the approximate distance being calculated by multiplying a measured differential of the value times a conversion constant; wherein the approximate distance is adjusted to take into account non-linearity of the measured differential.

16. A computing device as in claim 15 wherein the measured differential is a measured capacitance differential.

17. A computing device as in claim 15 wherein adjusting the approximate distance is performed using a first order correction value.

18. A computing device as in claim 15 wherein adjusting the approximate distance is performed using one or more tables.

19. A computing device as in claim 15 wherein adjusting the approximate distance in an “x” direction is performed using the following equation:
If |A|<=Start, then
Delta X=A
If |A|>Start, then
If A>0, then
Delta X=A+(A−Start)*Slope
If A<0, then
Delta X=A+(A+Start)*Slope
wherein A is the approximate distance in the x direction, Delta X is an adjusted value in the x direction, “Start” is a threshold value and “Slope” is a first order correctional value constant.

20. A computing device as in claim 15 wherein adjusting the approximate distance in a “y” direction is performed using the following equation:
If |B|<=Start, then
Delta X=B
If |B|>Start, then
If B>0, then
Delta X=B+(B−Start)*Slope
If B<0, then
Delta X=B+(B+Start)*Slope
wherein B is the approximate distance and Delta Y is an adjusted value in the Y direction.
